(19) United States
(12) Patent Application Publication
(10) Pub. No.: US 2017/0069021 A1
(43) Pub. Date: Mar. 9, 2017

(54) CREDIT SCORING BASED ON PERSONAL AND BUSINESS FINANCIAL INFORMATION

(71) Applicant: Creditera, LLC, South Jordan, UT (US)

(72) Inventor: David Levi King, South Jordan, UT (US)

(21) Appl. No.: 14/826,192

(22) Filed: Aug. 13, 2015

Related U.S. Application Data
(63) Continuation-in-part of application No. 13/713,743, filed on Dec. 13, 2012, now abandoned.
Application No. 13/713,743 is a continuation-in-part of application No. 13/785,984, filed on Mar. 5, 2013, now abandoned.
(60) Provisional application No. 62/036,625, filed on Aug. 13, 2014.

(51) Int. Cl. G06Q 40/02; G06Q 40/00

(52) U.S. Cl. CPC G06Q 40/025; G06Q 40/12

(57) ABSTRACT

A method directed to calculating and providing an enhanced credit scored based on personal credit information, business credit information, and/or user-provided financial data is disclosed.

### PRIORITY

This application claims priority to U.S. Provisional Patent Application Ser. No. 62/036,625 filed on Aug. 13, 2014; U.S. Provisional Patent Application Ser. No. 61/887,950 filed on Oct. 7, 2013; U.S. patent application Ser. No. 13/931,822 filed on Jun. 29, 2013; U.S. patent application Ser. No. 13/785,984 filed on Mar. 5, 2013, and U.S. patent application Ser. No. 13/713,743, filed on Dec. 13, 2012, each of which are herein incorporated by reference in their entireties.

### FIELD

This disclosure relates generally to credit scoring and reporting. More specifically, this disclosure relates to providing business and personal credit information scoring and delivery in a comprehensive format.

### BACKGROUND

The financial health of a business is often linked to the financial health of the individual or individuals that own or manage the business. This is particularly true with small businesses where there is a high degree of correlation between the owner's personal financial health and the financial health of the business.

Credit rating agencies such as Experian, Equifax, and others collect data regarding the financial health of individuals and businesses. The financial health is sometimes represented as a credit score for the individual or the business. Banks, vendors, and other creditors frequently rely on credit scores as a factor in determining whether or not to extend credit, and under what terms to extend credit to a business or an individual.

In some instances, the business or personal credit ratings may not accurately reflect the current financial situation of the borrower, and may not correctly reflect the risk being undertaken by the creditor. For example, FICO and Dunn and Bradstreet scores do not include use of bank accounts, or accounting practices, and are often incomplete without a comprehensive list of creditors and accounts. Individuals having a better view of the actual fiscal health of their personal and business finances have the ability and information to manage their finances to maximize potential and fiscal soundness.

### BRIEF SUMMARY

Methods, systems, and computer program products for providing access to an enhanced credit score generated using user-provided financial information along with business and personal credit information are disclosed. Embodiments can be embodied as a website, mobile application, or other interface for providing a single access point to access an enhanced credit score along with financial health and credit scores.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of disclosed and claimed methods will be set forth in the description which follows, and in part will be obvious from the description, or may be learned by implementing the methods. The features and advantages may be realized and obtained by means of the instruments and combinations particularly pointed out in the appended claims. These and other features will become more fully apparent from the following description and appended claims, or may be learned by implementation as set forth hereinafter.

### BRIEF DESCRIPTION OF THE DRAWINGS

In order to describe the manner in which the above-recited and other advantages and features can be obtained, a more particular description of the methods briefly described above will be provided by reference to specific embodiments which are illustrated in the appended drawings. The drawings depict only typical embodiments of the invention and are not, therefore, to be considered to be limiting of its scope. The invention will be described and explained with additional specificity and detail through the use of the accompanying drawings in which:

FIG. 1 illustrates an exemplary computing environment in which exemplary systems and methods of providing access to both personal and business credit information from which credit scores can be determined and reported can be implemented;

FIGS. 2A-2B illustrate communications that can occur between computing devices to receive a combined presentation of a personal credit score and a business credit score;

FIGS. 3A-3D and 4A-4B illustrate exemplary combined credit reports according to one or more embodiments;

FIGS. 5-8 each illustrate a flowchart of an exemplary method for generating a combined presentation of personal credit information and business credit information;

FIGS. 9-10 illustrates exemplary combined credit reports according to one or more embodiments; and

FIG. 11 illustrates a flowchart of an exemplary method for generating a combined presentation of personal credit information, business credit information, and/or an enhanced credit score.

### DETAILED DESCRIPTION

Methods, systems, and computer program products for providing access to a combined presentation of business and personal credit information are disclosed. Embodiments can be embodied as a website, mobile application, or other interface for providing a single access point to access an individual's personal credit information and business credit information of any businesses with which the individual is associated. The credit information may be provided as a combined presentation allowing access to both individual and business credit information from a single displayed page or site, or may provide both types of credit information in a single displayed page or site.

In one embodiment, a method for generating a combined presentation of personal credit information and business credit information may include a request from a client computing device requesting personal credit information of at least one individual and business credit information of a at least one business with which the at least one individual is associated. The personal credit information of the at least one individual and the business credit information of the at least one business may then be accessed. A combined presentation of the personal credit information and the business credit information may be generated. The combined presentation of access to the personal credit information and the business credit information may then be sent to the client computing device for display on the client computing device.

Exemplary methods, systems, and computer program products for providing access to business and personal credit information, including for multiple individuals and businesses, may include or utilize special purpose or general-purpose computers including computer hardware, such as, for example, one or more processors and system memory, as discussed in greater detail below. Embodiments may also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions may comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the disclosed embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

Methods, systems, and programs for providing access to business and personal credit information and combined display of that information may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

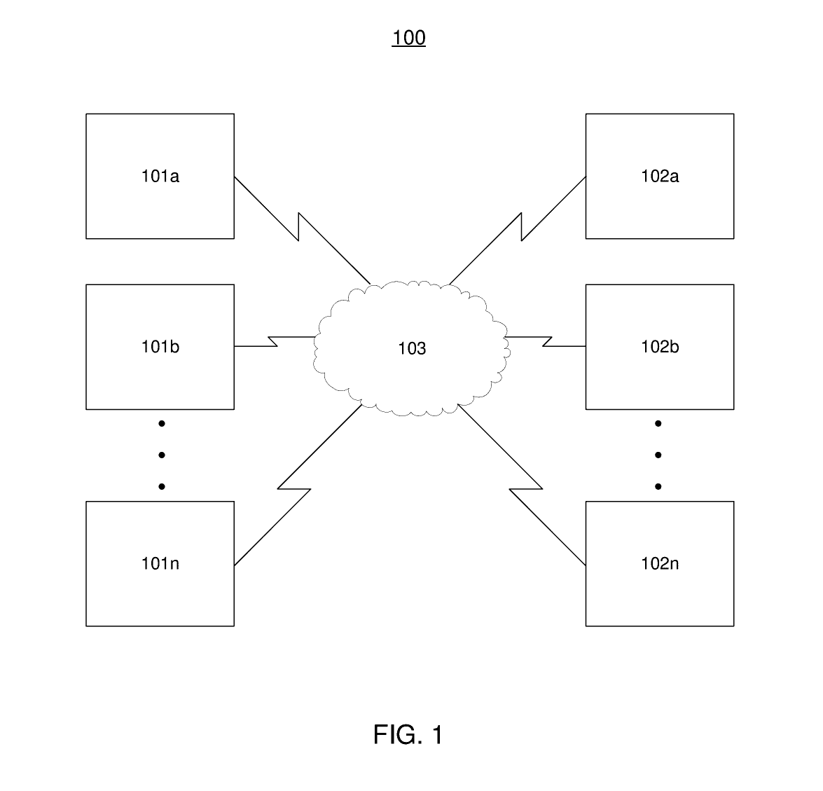

FIG. 1 illustrates an exemplary computer environment 100 in which embodiments of methods, systems, and programs for providing access to business and personal credit information can be implemented. Computer environment 100 may include server systems 101a-101n and client computer systems 102a-102n. Server systems 101a-101n may include any type of computer system that is accessible over a network. In a typical environment, server systems 101a-101n may include servers or clouds of server computing devices that are used by one or more businesses to supply information or services to clients.

Client computer systems 102a-102n may include any type of computing device that can connect to one or more of server computer systems 101a-101n via network 103. For example, client computer systems 102a-102n may include a mobile phone, a tablet, a laptop, a desktop computer, etc. that connects to server computer systems 101a-101n via the internet.

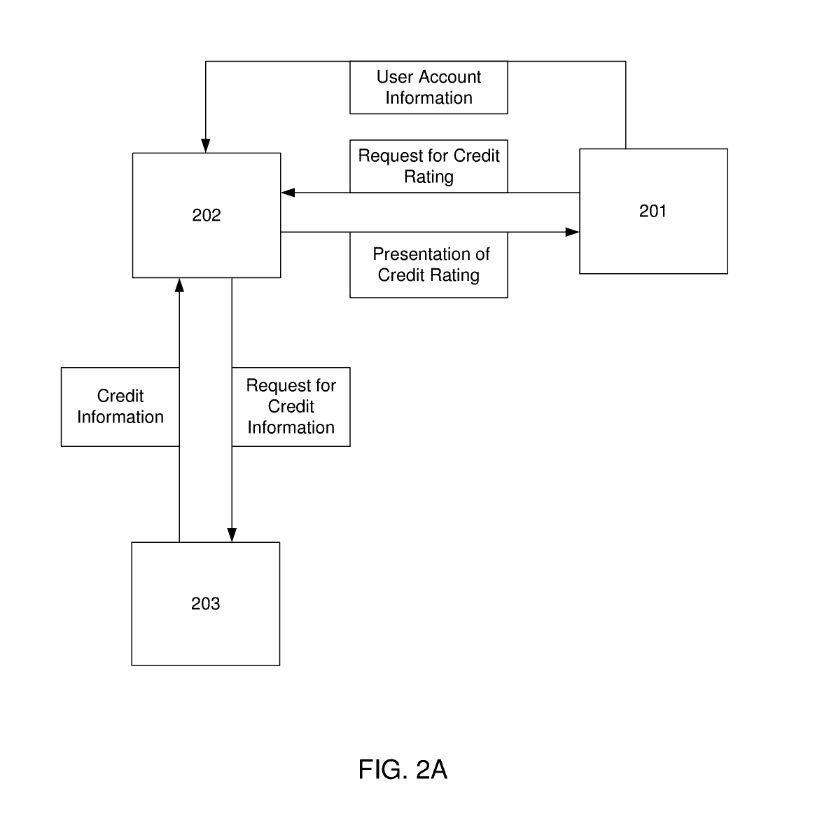

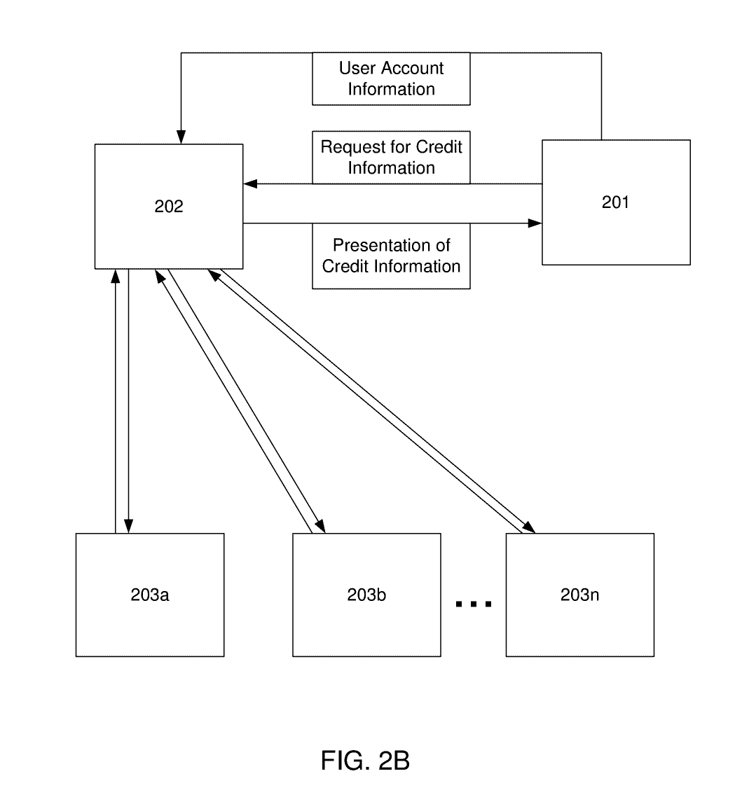

FIG. 2A illustrates an exemplary configuration of computer environment 100 in which a client computing device 201 may access a server system 202 to view a combined presentation of an individual's personal credit information and credit information of one or more businesses with which the individual is associated. In the remainder of the specification, credit scores are frequently used as specific examples of a type of credit information. However, credit information may include information other than a credit score of an individual or a business, such as credit-related information typically used to generate a credit score or rating, and/or other financial data such as bank account information, accounting software data, user-edited creditor identification information, etc.

As shown, server system 202 may receive credit information from server system 203. In this example, server system 202 can represent a server maintained by a first entity for providing a website where credit information can be obtained, and server system 203 can include a server system maintained by a credit bureau such as Experian, Transunion, Equifax, Dun and Bradstreet, etc.

Although FIG. 2A shows that credit information may be obtained from a single server system 203. In some embodiments, server system 202 can also obtain credit information from multiple different server systems. For example, server system 202 can obtain credit information from a server system maintained by Experian and a server system maintained by Transunion.

Server system 202 can be configured to obtain credit information regarding individuals and businesses both before a request for the information is received and in response to receiving a request for the information. For example, server system 202 can be configured to continuously compile credit information into a database so that server system 202 can respond to requests by accessing its own database. On the other hand, server system 202 can be configured to first receive a request for credit information before obtaining the requested information from server system 203. In other words, the specific manner in which server system 202 obtains credit information is flexible. In particular, embodiments of methods, systems, and programs for providing access to business and personal credit information could be implemented directly by a company that maintains credit scores for businesses or individuals and therefore may not need to access another server system to obtain a credit score for an individual or business.

Client computing device 201 can make requests to server system 202 over network 203 which is generally the internet, but can be any other network that interconnects the systems. These requests can be requests to view or download credit information relevant to a particular individual or business.

For example, client computing device 201 can submit a request to view credit information regarding a small business. In response to the request, server system 202 can access credit information and determine a business credit score for the small business. Additionally, server system 202 can determine that the small business is owned by a first individual, and can access credit information and determine the personal credit score for the first individual. As stated above, these two scores can be obtained by querying server system 203, accessing credit bureau information, or by accessing stored credit scores that had already been received by server system 202. Alternatively, these scores can be generated and maintained locally by server system 202 in which case, server system 202 need not access server system 203 to obtain the credit information.

Server system 202 can then generate a combined presentation of the small business's credit score and the first individual's credit score. This combined presentation can be returned to client computing device 201 for display on client computing device 201 such as in the form of a webpage, associated webpages, or application content. In this way, the user of client computing device 201, with a single request to server system 202, can receive a more complete view of the financial health and credit worthiness of the small business.

In another example, client computing device 201 can submit a request to view credit information regarding a second individual. Similar to the example above, server system 202 can access credit information and determine the personal credit score of the second individual, and can also determine if the second individual owns or is otherwise associated with a business. If the second individual owns any businesses, server system 202 can obtain the business credit information of each business and can generate a combined presentation of the second individual's personal credit information and the business' credit information of any associated businesses.

FIG. 2B illustrates an implementation when server system 202 accesses three or more other server systems 203a-203n to obtain credit information for generating a combined presentation of credit scores. For example, server systems 203a-203n can represent three or more separate credit bureaus, including personal credit and business credit bureaus.

In this example, server system 202 can request a personal credit score and a business credit score from each of server systems 203a-203n. Alternatively, server system 202 can request only a personal credit score from one of server systems 203a-203n and only a business credit score from another of server systems 203a-203n. In any case, in this example, server system 202 can receive many different credit scores (e.g. various separate personal credit scores and various separate business credit scores). The combined presentation of the credit information returned to client computing device 201 can include any or all of these credit scores obtained by server system 202. Of course, this example applies equally to scenarios where a different number of servers 203 are accessed to retrieve credit information.

Server system 202 can use various criteria to determine which individuals are associated with a business in such a way that the individual's credit score would be relevant to the business's credit score and vice versa. In the most basic example, the credit score of an owner of the business can be deemed relevant to the credit score of the business and vice versa. In a more complex example, server system 202 can use criteria such as percent of ownership, management role, etc. to determine whether an individual's credit score is likely to affect or be affected by the credit score of the associated business.

In other embodiments, server system 202 can allow client computing device 201 to specify an individual and any associated businesses in the request. For example, the user of client computing device 201 may already know that an individual is an owner of a business, and can request credit information for the individual and the business using a single request to server system 202. In such cases, server system 202 can use criteria to determine whether to include or suggest including the credit information of any other businesses an individual may be associated with. Similarly, server system 202 can use criteria to determine whether to include or suggest including the credit information of any other individual associated with a specified business.

In addition to allowing a user to make requests for combined personal and business credit information, embodiments of methods, systems, and programs for providing access to business and personal credit information can also allow a user to receive alerts regarding any of the linked credit reports. For example, client computing device 201 can register with server system 202 to receive an alert when there is a change in the credit score of a business or in the credit score of any associated individual. In this way, the user can be automatically notified of a change to any of the associated credit scores or other relevant credit information.

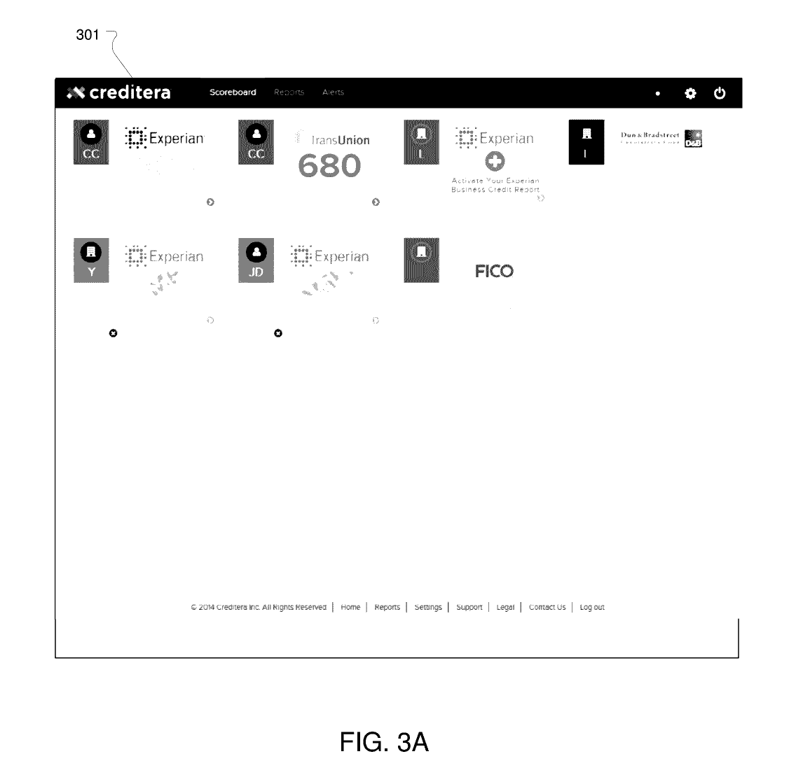

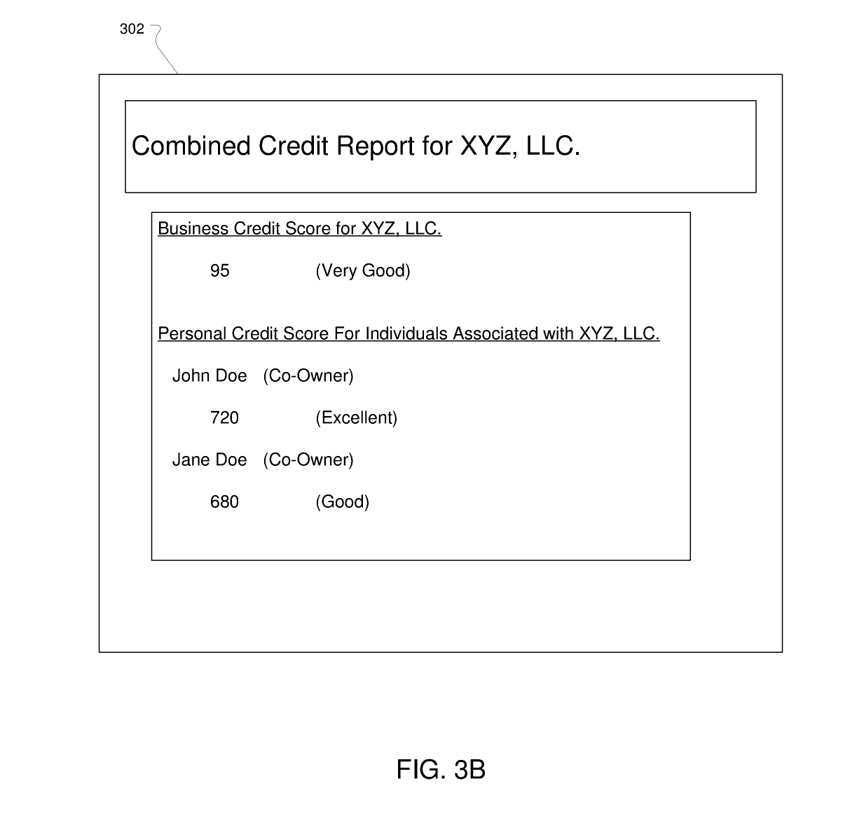

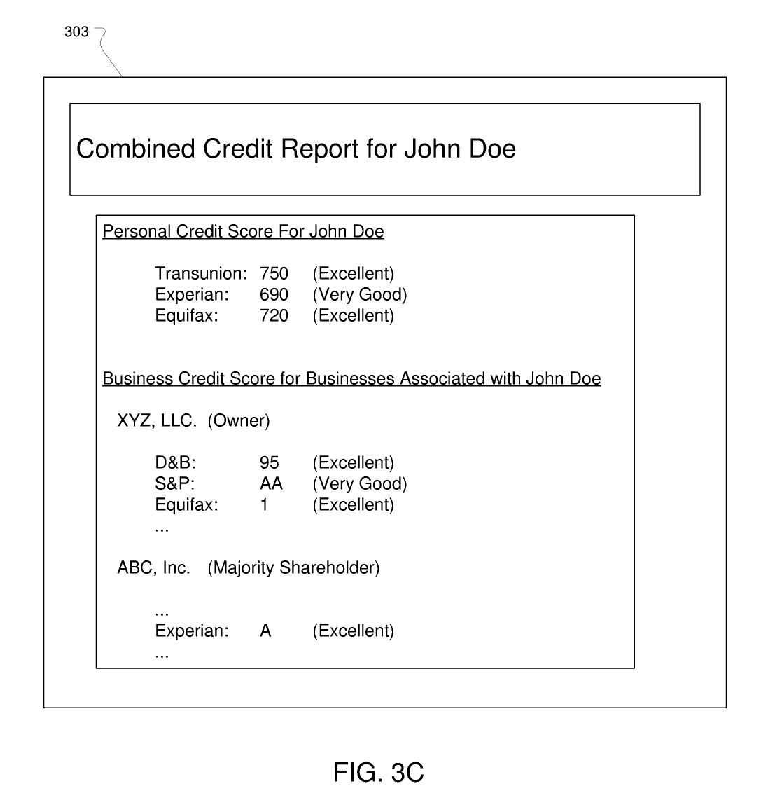

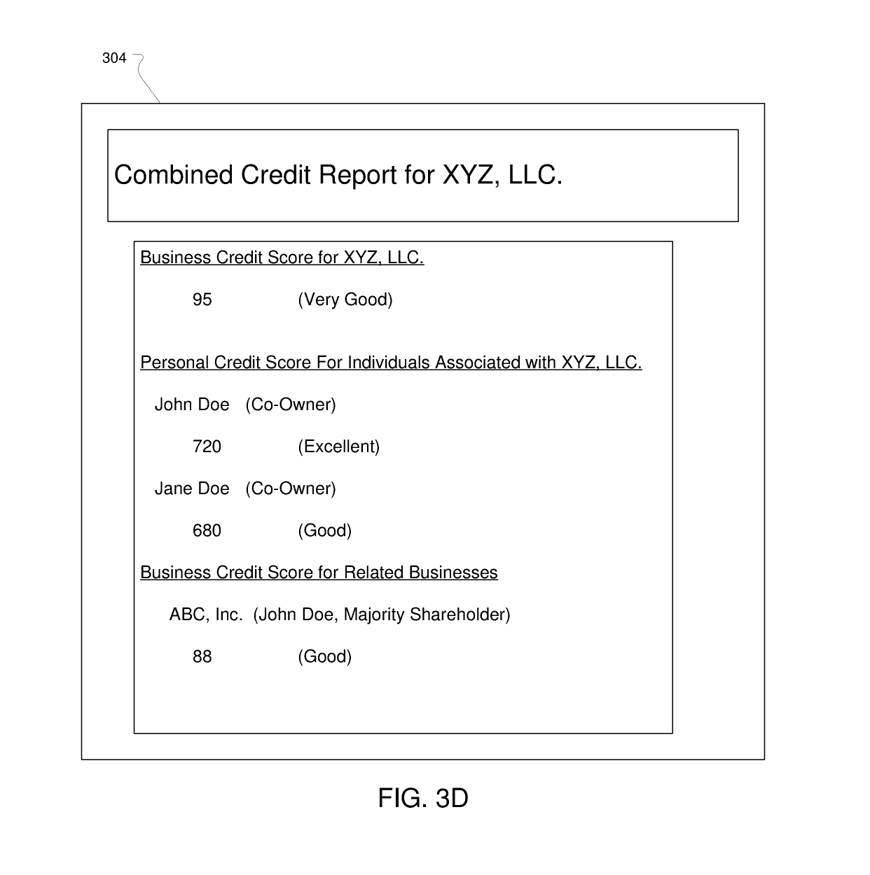

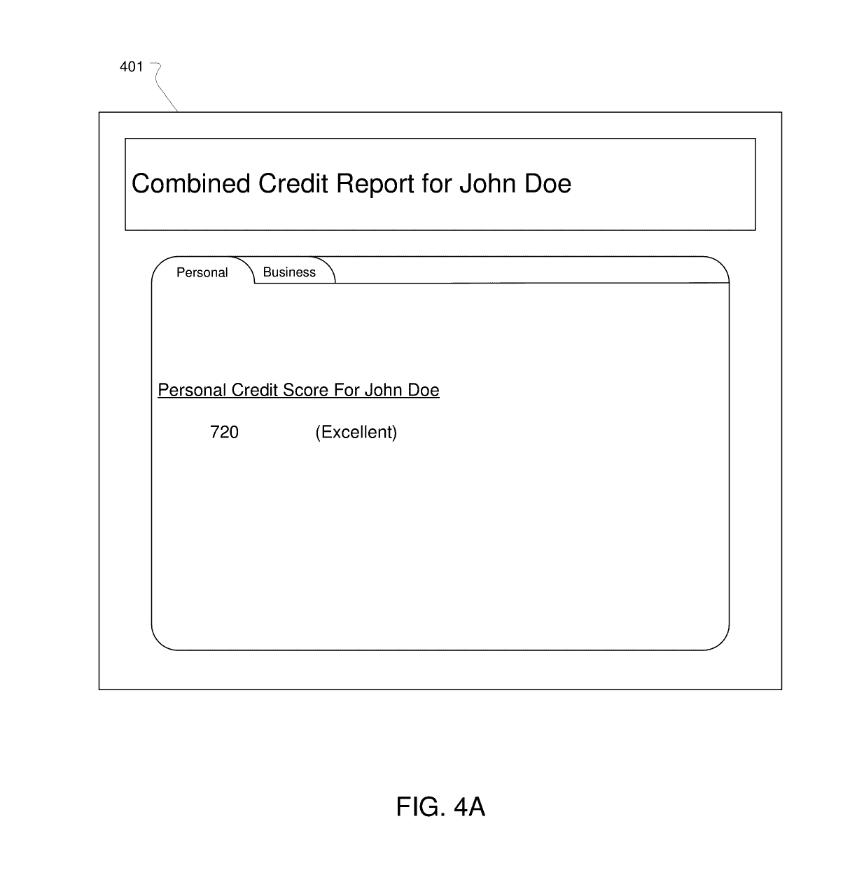

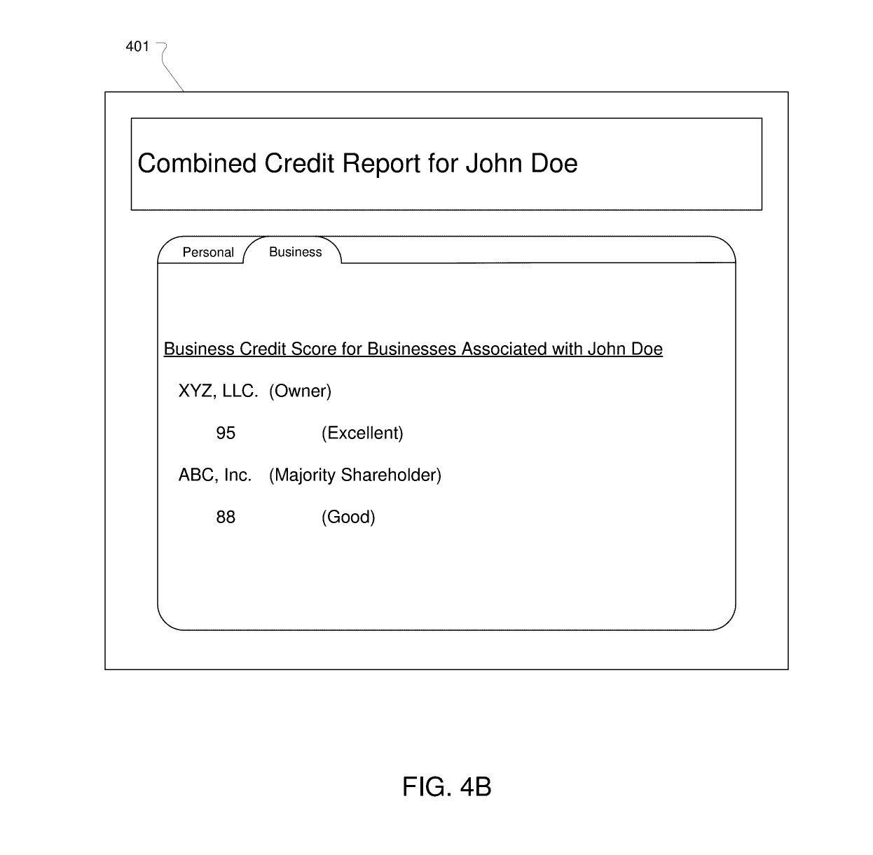

FIGS. 3 and 4 illustrate various exemplary combined presentations of personal and business credit information. In some embodiments, a combined presentation may include a display that is accessible using a single user account or login. For example, if the combined presentation is provided in a website, a user can access the combined presentation using a single set of login credentials (e.g. username and password). In this manner, the combined presentation can be more easily and quickly accessed. FIG. 3 illustrates various examples where the combined presentation may include a single screen that includes both personal and business credit information or one or more individuals and/or businesses. On the other hand, FIG. 4 illustrates various examples where the combined presentation may include different screens for the personal and business credit information. Each of the embodiments may be accessible from a common account or login.

FIG. 3A illustrates an exemplary combined credit report 301 for an individual, John Doe. Report 301 can be generated in response to a request to view John Doe's personal credit score and the business credit score of any businesses with which John Doe is associated.

Report 301 may include a personal credit scores of 605 and 680 for John Doe from different bureaus. A personal credit score can be based on any combination of credit scores reported by the various credit agencies. For example, it can be a single score reported by one credit agency, or a combination of scores reported by the three major personal credit reporting agencies (average, mean, etc.), or may be displayed the top, bottom, or middle score, as desired.

Report 301 may also include a business credit score for two businesses with which John Doe is associated. A first business, L, which John Doe owns, has a business credit score pending through one bureau, while a second business, Y, of which John Doe is a majority shareholder, has a business credit score of 35 from a different bureau. Like the personal credit score, the business credit scores can be based on any number of the scores reported by the various business credit agencies.

FIG. 3B illustrates another exemplary combined credit report 302 for the business, XYZ, LLC. Report 302 can be generated in response to a request to view XYZ's business credit score and the personal credit score of individuals associated with XYZ, LLC. Report 302 may provide the business credit score of 95, and also provide the personal credit score of two owners of XYZ, LLC., John Doe (720) and Jane Doe (680).

FIG. 3C illustrates another exemplary combined credit report 303 which is a more detailed version of combined credit report 301. As shown, report 303 may include multiple credit scores for John Doe, XYZ, LLC., and ABC, Inc. Specifically, John Doe's personal credit scores with the three major credit agencies are listed. Similarly, each business's credit score with a number of business credit agencies may be listed.

Each business credit agency uses its own scale for reporting a business's credit score. In some embodiments, as shown in report 303, each of these scores can be listed. In other embodiments, a combined score can be generated to report a business's credit score. For example, embodiments of the present invention can define its own scale to provide a single credit score that is based on the combination of any number of the scores provided by business credit agencies.

Additionally, other credit information and full credit reports may be provided. Links may be provided to access, generate, or display a single credit report from each of the credit reporting agencies by clicking on the reported score or reporting agency listed under each entity. For example, if the “S&P” or “AA” is clicked under the XYX, LLC. listing, credit information provided by S&P on XYZ may be provided or displayed. Similarly, selected portions of the credit information may be presented based on pre-selected filters, such as for loan information only, or for credit inquiries, negatives, and other information in addition.

FIG. 3D illustrates another exemplary combined credit report 304 which is similar to report 302 with the addition of the business credit score of ABC, Inc. In some embodiments, the business credit scores of related businesses can also be provided when a user requests a business's credit score. In report 304, ABC, Inc.'s credit score is also reported because it is determined that ABC's credit score is likely relevant to XYZ's credit score because John Doe is associated with both businesses. In some embodiment, the level of detail provided in a report can be a user configurable option.

FIGS. 4A and 4B illustrate an exemplary combined credit report 401 that includes a tab for personal credit information and a tab for business credit information. Combined credit report 401 is similar to combined credit report 301 shown in FIG. 3A. In some embodiments, a separate tab can be provided for each individual and business included in a combined credit report. Of course, other user interface designs can also be used such as by providing other types of links to each additional screen or report of a combined credit report.

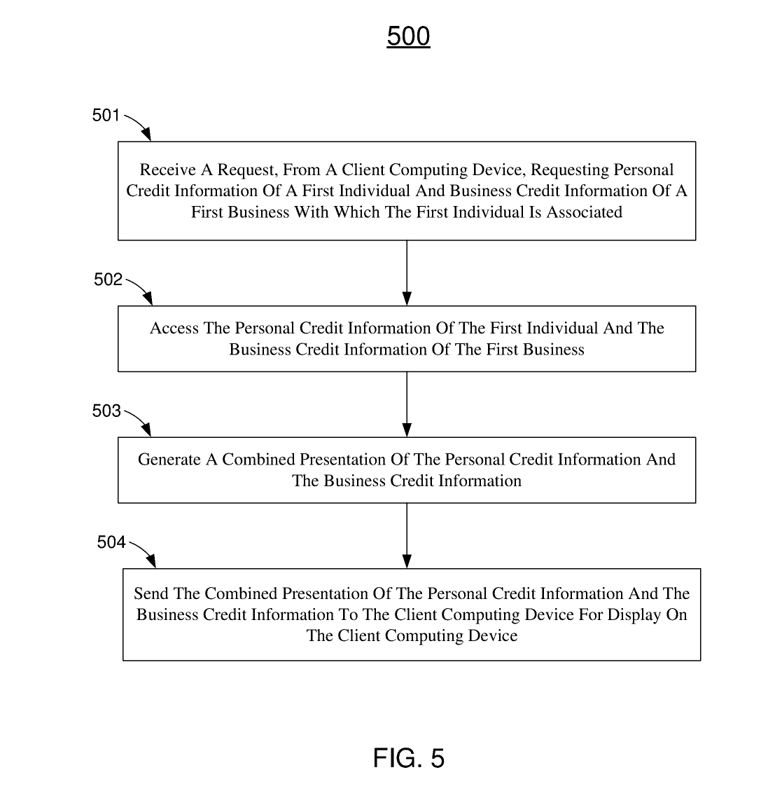

FIG. 5 illustrates a flowchart of an exemplary method 500 for generating a combined presentation of a personal credit score and a business credit score. Method 500 will be described with respect to the Figures.

Method 500 may include an act 501 of receiving a request, from a client computing device, requesting a personal credit score of a first individual and a business credit score of a first business with which the first individual is associated. For example, server system 202 can receive a request from client computing device 201 for the personal credit score of an individual and the business credit score of a business owned by the individual. Method 500 may also include an act 502 of accessing the personal credit information of the first individual and the business credit information of the first business. For example, server system 202 can access the personal and business credit information from one or more other server systems 203, or can access locally stored personal and business credit information.

Method 500 may include an act 503 of generating a combined presentation of the personal credit information and the business credit information. For example, server system 202 can generate a webpage that includes a report (e.g. any of reports 301-304 or 401) that includes a listing of personal and business credit information. Method 500 may further include an act 504 of sending the combined presentation of the personal credit information and the business credit information to the client computing device for display on the client computing device. For example, server system 202 can return the generated webpage to client computing device 201.

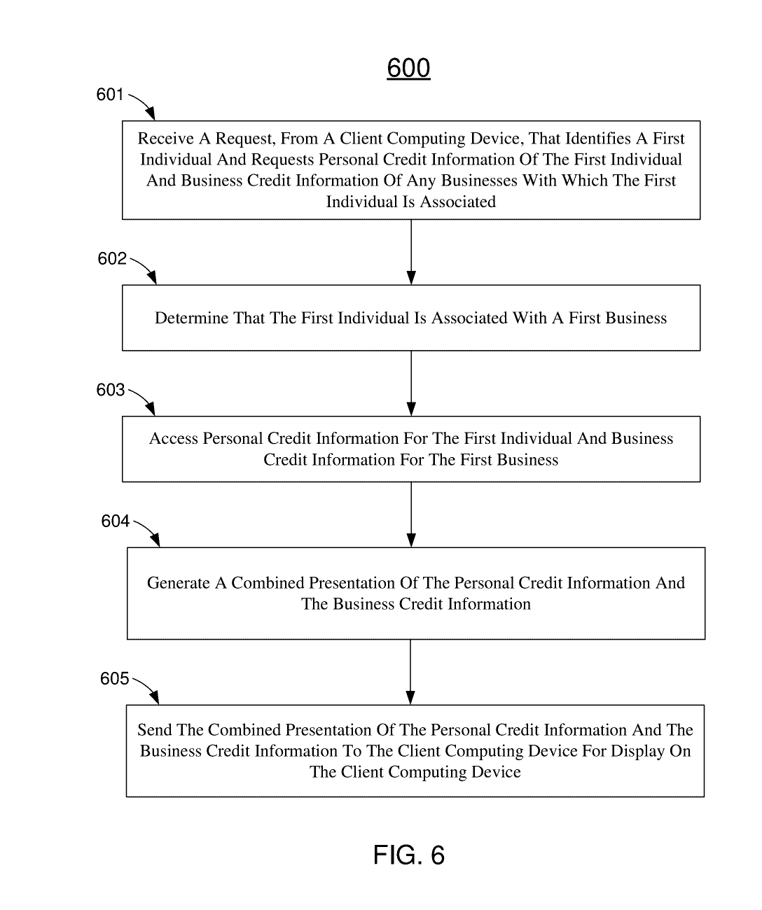

FIG. 6 illustrates a flowchart of an exemplary method 600 for generating a combined presentation of personal credit information and business credit information. Method 600 will be described with respect to the Figures.

Method 600 may include an act 601 of receiving a request, from a client computing device, that identifies a first individual and requests personal credit information of the first individual and business credit information of any businesses with which the first individual is associated. For example, server system 202 can receive a request from client computing device 201 for personal credit information of an individual and business credit information of any businesses with which the individual is associated. Method 600 may further include an act 602 of determining that the first individual is associated with a first business. For example, server system 202 can determine that the individual owns a business.

Method 600 may include an act 603 of accessing a personal credit information for the first individual and a business credit information for the first business. For example, server system 202 can access the personal and business credit information from one or more other server systems 203, or can access locally stored personal and business credit information. Method 600 may also include an act 604 of generating a combined presentation of the personal credit information and the business credit information. For example, server system 202 can generate a webpage that includes a report (e.g. any of reports 301-304 or 401) that includes a listing of the personal and business credit information.

Method 600 may also include an act 605 of sending the combined presentation of the personal credit information and the business credit information to the client computing device for display on the client computing device. For example, server system 202 can return the generated webpage to client computing device 201.

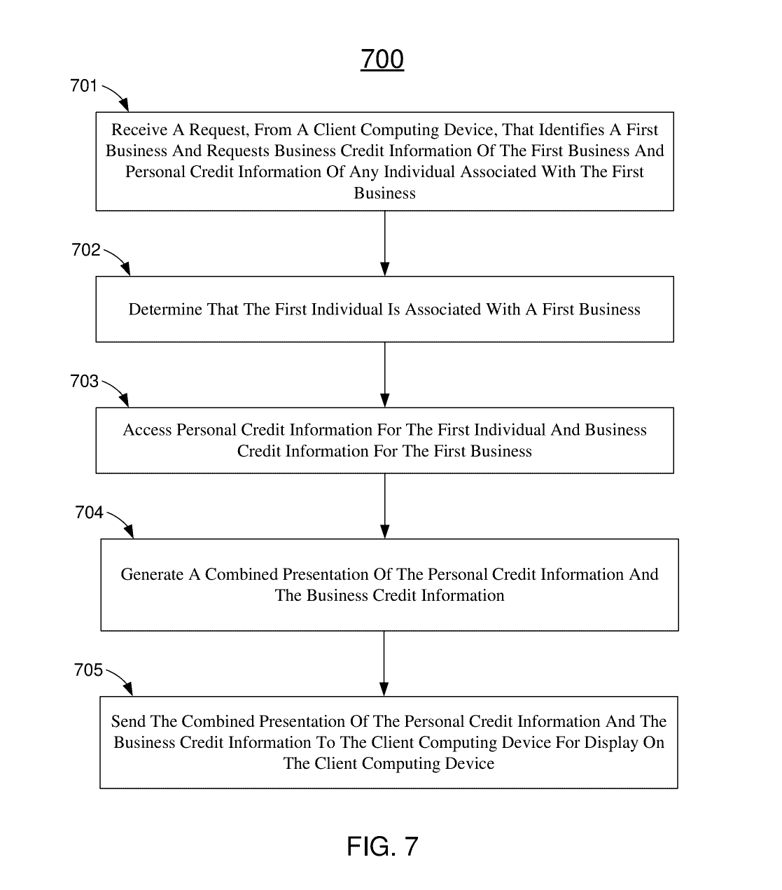

FIG. 7 illustrates a flowchart of an exemplary method 700 for generating a combined presentation of personal credit information and business credit information. Method 700 will be described with respect to the Figures.

Method 700 may include an act 701 of receiving a request, from a client computing device, that identifies a first business and requests a business credit information of the first business and a personal credit information of any individual associated with the first business. For example, server system 202 can receive a request from client computing device 201 for the business credit information of a business and the personal credit information of any individuals associated with the business.

Method 700 may also include an act 702 of determining that the first individual is associated with a first business. For example, server system 202 can determine that one or more individuals own the business. Method 700 may further include an act 703 of accessing a personal credit information for the first individual and a business credit information for the first business. For example, server system 202 can access the personal and business credit information from one or more other server systems 203, or can access a locally stored personal and business credit information.

Method 700 may include an act 704 of generating a combined presentation of the personal credit information and the business credit information. For example, server system 202 can generate a webpage that includes a report (e.g. any of reports 301-304 or 401) that includes a listing of the personal and business credit information. Method 700 may also include an act 705 of sending the combined presentation of the personal credit information and the business credit information to the client computing device for display on the client computing device. For example, server system 202 can return the generated webpage to client computing device 201.

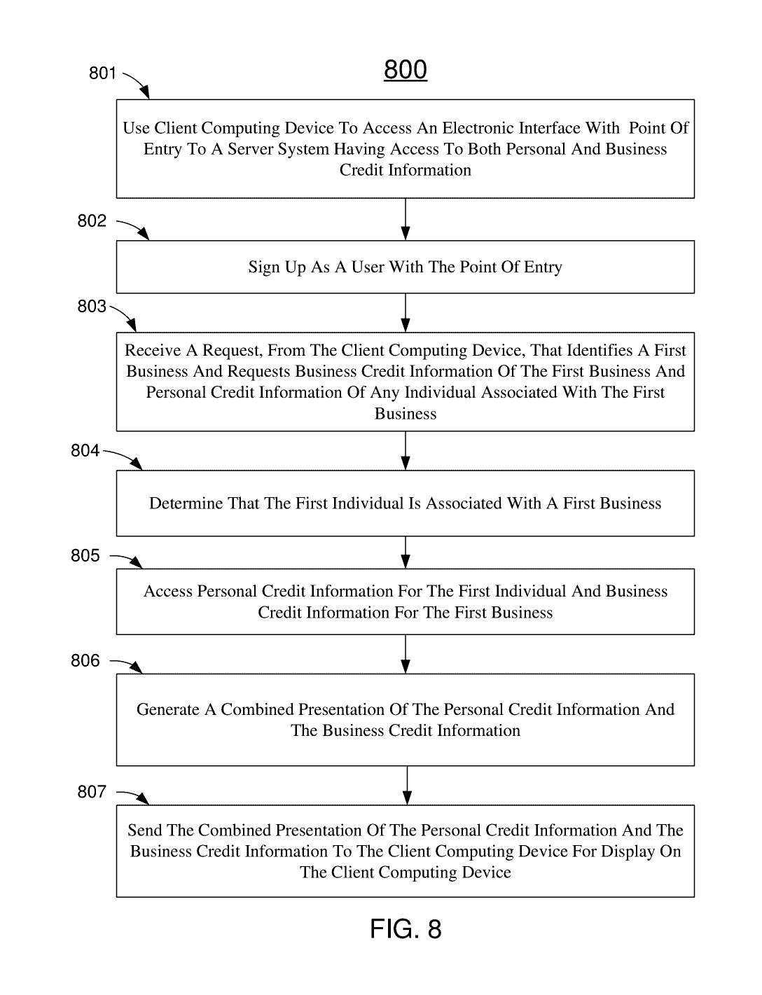

FIG. 8 illustrates a flowchart of an exemplary method 800 for signing up through a point of entry to server system 202 for generating a combined presentation of personal credit information and business credit information. Method 800 will be described with respect to the Figures.

Method 800 may include an acts 801 and 802 of using a client computing device to access server system 202 by signing-up for a credit service through a point of entry to server system 202 to provide access to both personal and business credit information. For example, a user may use a computing device to provide identifying information and create a profile through the point of entry to create a profile and credentials that allows the user to access server system 202 to view and/or manage personal and credit information. In other words, a user may acquire a login at a single website to view both personal and business credit information corresponding to the user.

Method 800 may also include act 803 of receiving a request, from a client computing device, that identifies a first business and requests a business credit information of the first business and a personal credit information of any individual associated with the first business. For example, server system 202 can receive a request from client computing device 201 for the business credit information of a business and the personal credit information of any individuals associated with the business.

Method 800 may also include an act 804 of determining that the first individual is associated with a first business. For example, server system 202 can determine that one or more individuals own the business. Method 800 may further include an act 805 of accessing a personal credit information for the first individual and a business credit information for the first business. For example, server system 202 can access the personal and business credit information from one or more other server systems 203, or can access a locally stored personal and business credit information.

Method 800 may include an act 806 of generating a combined presentation of the personal credit information and the business credit information. For example, server system 202 can generate a webpage that includes a report (e.g. any of reports 301-304 or 401) that includes a listing of the personal and business credit information. Method 800 may also include an act 807 of sending the combined presentation of the personal credit information and the business credit information to the client computing device for display on the client computing device. For example, server system 202 can return the generated webpage to client computing device 201.

In some embodiments, each individual credit score and tool tab for each profile may be clicked to reveal detailed credit information, such as a full credit report, a listing of accounts, etc., including the option of uploading personal account information from bank and brokerage accounts, and accounting data (P&L, categorized expenses, income, etc.) to provide additional information and tools for managing credit. Similarly, each profile may include an “alerts” tab to draw attention to changes to the credit profile that may require attention, such as significant additions to the credit report, negative reporting by an agency, information regarding blocked credit inquiries if a credit management system is in use, or other information that may lend itself to alerting the user. A variety of reports may also be available under a “reports” tab to provide organized data. Total amounts of current accounts may be provided, along with a snapshot of minimum payments required for each person to allow an easy idea of the ongoing credit liabilities of any individual having a profile on the combined report 901.

Additionally, (as best shown in FIG. 3A) other individuals and businesses may be added for a quick view associated individuals and businesses. For example, a second company and profile may be added by clicking on an “add another business” tab, or something similar. In some embodiments, combined credit report 901 may be for business partners, other than spouses, along with their business interests. This combined report may allow for better credit management and coordination between spouses or business partners, or between any individuals where a combined report may be desired.

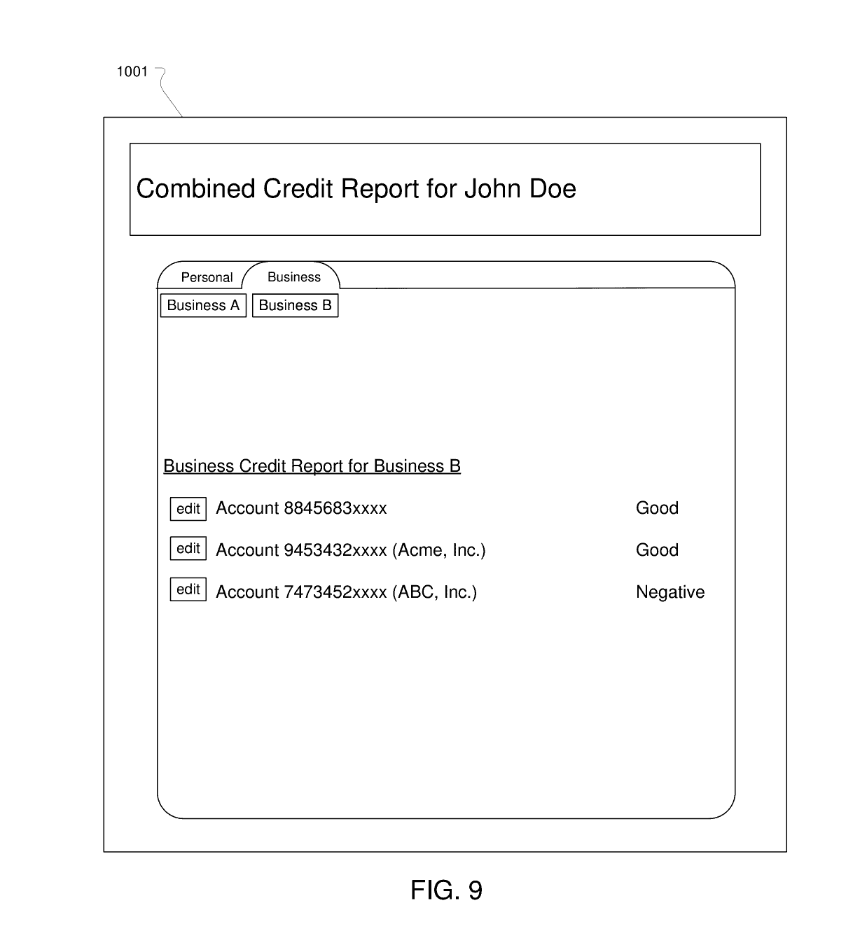

FIG. 9 illustrates an exemplary combined credit report 1001 for an individual, John Doe and Business A and Business B associated with John Doe. Report 1001 may also include additional related individuals, such as the spouse of John Doe, a business partner in either of the businesses, or other related individual, such as is described above. Report 1001 can be generated in response to a request to view a combined credit display of John Doe's personal credit information and the business credit information of any businesses with which John Doe is associated, as well as the credit information of any other associated individual.

Report 1001 may include a personal credit score for John Doe, as well as creditor account information associated with John Doe or any businesses associated with John Doe. Report 1001 may also include credit information for two businesses with which John Doe is associated. A first business, Business A, which John Doe owns, and a second business, Business B, of which John Doe is a majority shareholder.

Like the personal credit score, business credit information may include business credit scores based on any number of the scores reported by the various business credit agencies, and may also include account information for the accounts reported to derive the credit score. Generally, business credit reports do not include the names of the creditor accounts, but only account numbers, which may provide some difficulty in identifying the creditor to which that account belongs. In many cases, the creditor name may be identified by account number, payment history and amount, or other information included in the credit report.

In some embodiments, the combined credit report 1001 may be edited by a user to include company name information for a creditor along with the account number provided by the credit reporting agencies. When such creditor companies are identified and the name of the creditor company added, the information may be saved on the servers and may be suggested to other users who have unidentified creditor accounts having similar account numbers. For example, in many cases, creditor company will use between a six and twenty digit account number. The first several digits of those numbers are often common among many or all of the clients of that creditor company, or at least common amount a group of similar clients. Thus, by comparing the first several digits of an account number known to be an account of a particular creditor with other account numbers of other users processed through the servers, a probable association may be made as to the creditor company information for other users. Those other users may then be prompted with the probably identity and may confirm or reject the suggested creditor identity associated with a particular account number, providing additional enhanced information with the combined credit report 1001 than is generally available from credit reporting agencies alone.

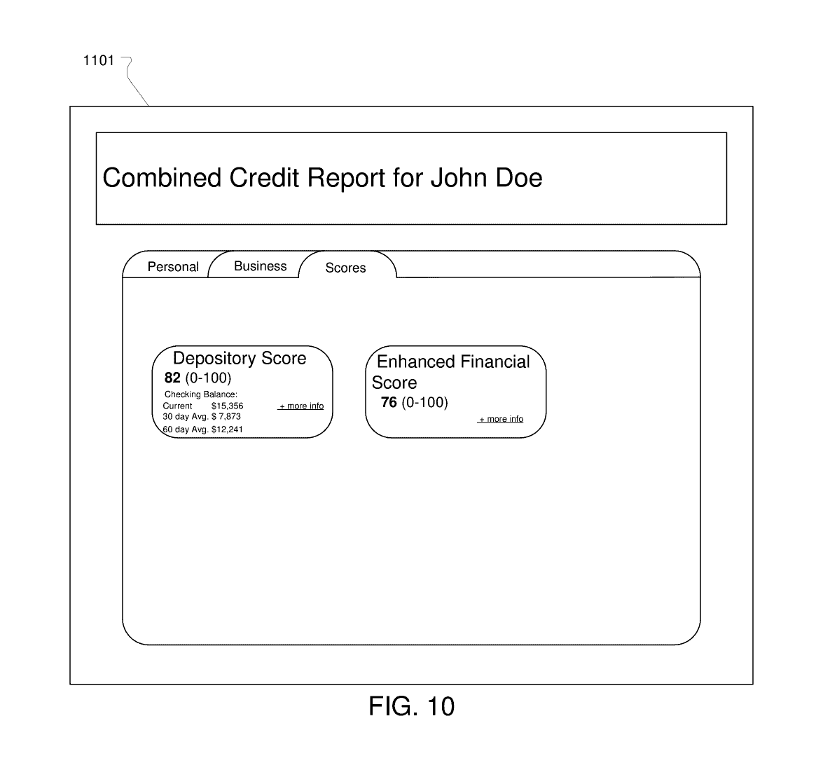

FIG. 10 illustrates an exemplary combined credit report 1101 for an individual, John Doe, Businesses associated with John Doe, and additional enhanced credit scores that may provide a quick look at fiscal health that traditional credit scores such as FICO and the traditional Bureau scores may not provide. For example, one enhanced credit score may be a “depository score”. A depository score may access primary checking account information for John Doe, any business associated with John Doe, or a combination of all associated accounts. The primary checking account information may provide trends in spending, cash-flow management, and income over various periods of time. In some embodiments, users may select a desired time period to see the average balance, or may access other generated reports on spending trends, balance trends, income trends, etc.

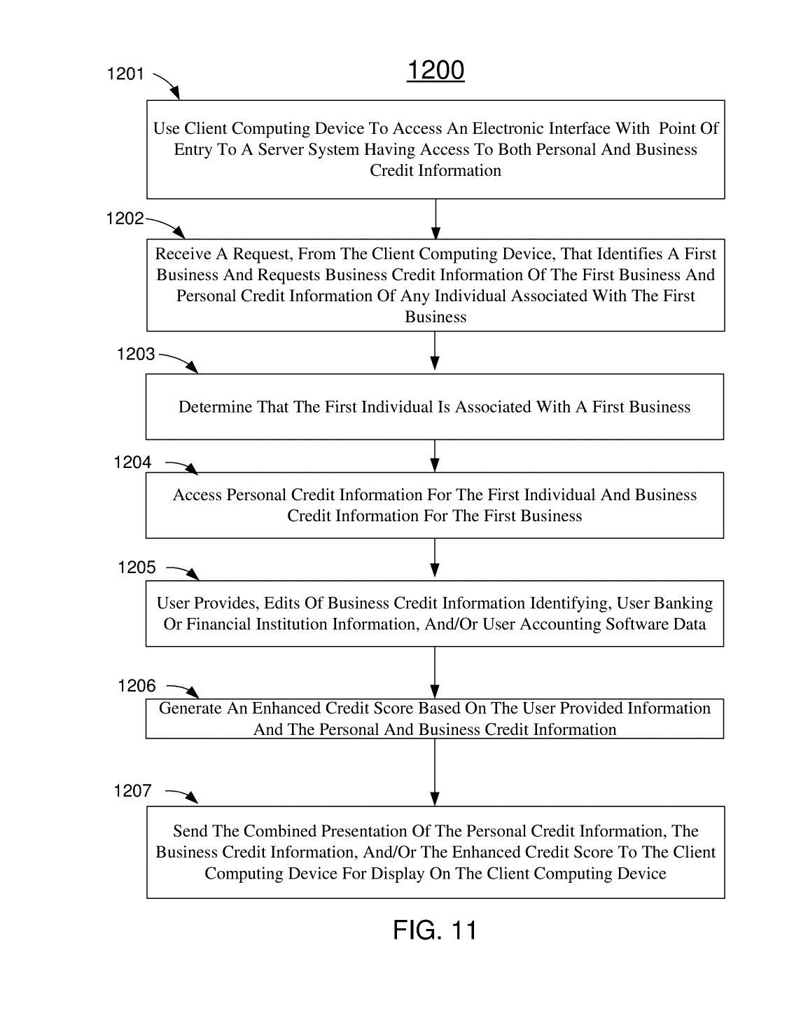

FIG. 11 illustrates a flowchart of an exemplary method 1200 for accessing a point of entry to server system 202 for accessing a combined presentation of personal credit information, business credit information, and/or enhanced credit scores. Method 1200 will be described with respect to the Figures.

Method 1200 may include an acts 1201 and 1202 of using a client computing device to access server system 202 and requesting, from a client computing device, information that identifies a first business and requests a business credit information of the first business and a personal credit information of any individual associated with the first business. For example, server system 202 can receive a request from client computing device 201 for the business credit information of a business and the personal credit information of any individuals associated with the business.

Method 1200 may also include an act 1203 of determining that the first individual is associated with a first business. For example, server system 202 can determine that one or more individuals own the business. Method 1200 may further include an act 1204 of accessing a personal credit information for the first individual and a business credit information for the first business. For example, server system 202 can access the personal and business credit information from one or more other server systems 203, or can access locally stored personal and business credit information.

Method 1200 may include an act 1205 of a user providing access to banking information, user accounting software data, and/or edits of business credit information (such as that discussed with respect to FIG. 10 above). This information may be referred to as user financial information. Act 1206 may provide for a generated enhanced credit score based at least in part on the user financial information provided by the user in act 1205 along with the personal and business credit information retrieved from server systems 203.

The enhanced credit score may be calculated by weighing the user financial information, the personal credit information, and the business credit information. A personal audit score may be generated based solely on the user financial information. For example, such a score may be generated on a 0-100 scale or another scale. One exemplary personal audit score (PAS) may be generated by the following:

$$PAS = 1 - ( \frac{1}{\frac{4 x business revenue}{bsns costs + bsns debt} + \frac{pers assets + ( 3 x pers income )}{pers debt}} )$$

Where if either of the business or personal components is negative, it would be scored as a zero. The PAS may also be calculated using other similar formulas that would include any desired information relating to the personal and business financial health of the user, as described above, to possibly include bank balances, bank balance averages, debt loads, asset values, a differentiation between cash and non-liquid assets, etc.

Similarly, a formula may be applied as follows to generate an Enhanced Credit Score (ECS):

$$ECS = \frac{D \& B Percentile}{3} + \frac{\frac{FICO - 300}{530}}{3} + \frac{PAS}{3}$$

Of course, where there is more than one business score, the D&B component may be modified to achieve an appropriate score to include all businesses, or another business reporting credit score may be averaged with or used instead of the D&B score. Similarly, instead of FICO, any of the three main personal credit reporting agency scores or an average of the three may be used with a modified formula to achieve the score as well. In other embodiments, other financial factors may be included. Additionally, the weighting of the various components may be modified depending on whether a particular emphasis is desired. Of course, other permutations or modifications of the formula above may be used to obtain an ECS providing a more comprehensive financial view for a user.

The ECS may thus provide a more complete overall financial picture by incorporating factors and information that are excluded from all current public credit scoring agencies. In some embodiments, the user financial information may be input by the user, or may be obtained with the user's permission from financial institutions, accounting software, etc., on a permission or ongoing basis. Because the ECS may provide a more complete picture of financial health, lenders may find the ECS useful in making lending decisions.

Method 1200 may also include an act 1207 of sending the combined presentation of the personal credit information, business credit information, and/or enhanced credit score to the client computing device for display on the client computing device. For example, server system 202 can return the generated webpage to client computing device 201.

In some embodiments, the confidence in or validity of the ECS may be checked by comparing the generated ECS against an ECS based solely on information obtained through banks or other financial institutions. This may be done to verify the validity of the data from accounting software or services, which may include human error or exaggerations conflicting with or not reflected in actual account balances.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

What is claimed:

1. A method, performed by a computer system, for providing an enhanced credit score, comprising:
a first individual using a client computer device to access credit information associated with the first individual from a first credit bureau and credit information associated with the first individual from a second credit bureau;
providing additional financial information by the first individual using a client computer device;
calculating an enhanced credit score based on the credit information from the first and second credit bureaus and the additional financial information;
sending the enhanced credit score to the client computing device; and
displaying the enhanced credit score on a display on the client computing device.

2. The method of claim 1, further comprising:
displaying the credit information from the first and second credit bureaus along with the enhanced credit score on the client computing device.

3. The method of claim 1, wherein the calculating an enhanced credit score includes first calculating a personal audit score based on the additional financial information alone.

4. The method of claim 1, wherein the additional financial information includes private information of the user.

5. The method of claim 1, wherein the additional financial information includes information selected from the following: bank account statements; bank account balance averages, and accounting software data.

6. The method of claim 6, wherein the providing additional financial information includes a user authorization for the additional financial information to be retrieved electronically from a financial institution and/or accounting software managed by the user.

7. The method of claim 1, further comprising: sending the enhanced credit score to a lender.

8. The method of claim 7, further comprising evaluating the enhanced credit score for accuracy.
